(19) United States
(12) Patent Application Publication
(10) Pub. No.: US 2016/0286745 A1
(43) Pub. Date: Oct. 6, 2016

(54) ROOT WATERING AND FEEDING DEVICE

(71) Applicants: Pamela Louise Riffe, Fairfax Station, VA (US); Brian Douglas Riffe, Fairfax Station, VA (US)

(72) Inventors: Pamela Louise Riffe, Fairfax Station, VA (US); Brian Douglas Riffe, Fairfax Station, VA (US)

(21) Appl. No.: 14/677,998

(22) Filed: Apr. 3, 2015

(51) Int. Cl. A01G 29/00

(52) U.S. Cl. CPC A01G 29/00

(57) ABSTRACT

A root watering and feeding device may include an interchangeable liquid collection basin that may be operably connected to an elongated hollow tube that includes perforations. The liquid collection basin may include a tapered or non-tapered hole that allows water to pass from the liquid collection basin, through the elongated hollow tube, and out of the perforations into the soil. A kit of liquid collection basins and/or elongated hollow tubes may be provided such that a desirable root watering device for a plant or a type of plant may be assembled.

### FIELD

The present invention generally relates to the watering and feeding of plant roots, and in particular, to a plant root watering and feeding device configured to deliver water and/or nutrients directly to or proximate to the root systems of plants.

### BACKGROUND

When a plant is watered by applying water to the ground surface via a sprinkler, a garden hose, rain, or the like, most of the water runs off or evaporates before penetrating the soil to an effective depth where plant roots can absorb the water in a manner that will promote deep root growth and a healthier plant, and not shallow root growth and a weaker plant. As such, water applied in this manner generally does not reach the roots in a sufficient manner to ensure optimal growth, unless a sufficiently large amount of water is applied to overcome the water that runs off or evaporates. Accordingly, this approach is relatively ineffective and/or wasteful.

Soaker hoses that lie on top of the ground surface and allow water to seep slowly through the porous walls of the hose provide a more efficient way to water plants than other surface watering approaches. This is because the slow seepage allows more water to absorb into the soil, which reduces evaporation. However, evaporation does still occur, and soaker hoses do not provide the deep penetration of water/nutrients needed to encourage deep root growth. Soaker hoses and other hoses are connected to water faucets, which wastes water that could be used for drinking water or other applications. This is especially detrimental in environments that are prone to drought conditions. Also, these devices do not provide a mechanism for delivering liquid nutrients into soil.

Root feeding stakes are also known that are designed to deliver water and nutrients to the roots of plants. When properly installed, the perforations of some conventional root feeding stakes are inserted to a depth of only about three inches below the ground surface. However, this only feeds the upper portion of the soil and does not encourage deep root growth, which is beneficial for a healthy plant. In fact, and conversely to what is desirable, shallow root growth is encouraged. Shallow root growth makes the plant more susceptible to drought and requires more frequent watering than deep root growth. As such, these conventional root feeding stakes do not deliver water efficiently and limit the amount of water or liquid nutrients available to feed the plant. Accordingly, an improved device for delivering water and nutrients deeper into the soil to encourage deep root growth and to feed deep root systems may be beneficial.

### SUMMARY

Certain embodiments of the present invention may provide solutions to the problems and needs in the art that have not yet been fully identified, appreciated, or solved by current root watering and feeding technologies. For example, some embodiments of the present invention provide a root watering and feeding device that includes an interchangeable liquid collection basin that may be operably connected to an elongated hollow tube including a plurality of perforations. The liquid collection basin may include at least one hole in the center that allows water to pass from the liquid collection basin, through the elongated hollow tube, and out of the perforations into the soil.

In an embodiment, an apparatus includes an elongated hollow tube including a plurality of perforations. The apparatus also includes a detachable and interchangeable liquid collection basin configured to be attached to and detached from the elongated hollow tube at a proximal end thereof.

In another embodiment, a root watering and feeding kit includes an elongated hollow tube including a plurality of perforations. The root watering and feeding kit also includes a plurality of detachable and interchangeable liquid collection basins configured to be attached to and detached from the elongated hollow tube at a proximal end thereof.

In yet another embodiment, a root watering and feeding device includes an elongated hollow tube including a plurality of perforations. The root watering and feeding device also includes a detachable and interchangeable liquid collection basin configured to be attached to and detached from the elongated hollow tube at a proximal end thereof. The elongated hollow tube, the liquid collection basin, or both, include a designation indicating one or more plants or plant types that the elongated hollow tube, the liquid collection basin, or both, are configured to water.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIG. 1A is a side view of a root watering and feeding device with a detached liquid collection basin, according to an embodiment of the present invention.

FIG. 1B is a side view of the root watering and feeding device with the liquid collection basin attached, according to an embodiment of the present invention.

FIG. 2 is a side view of multiple elongated tube sections with different perforation patterns and shapes, according to an embodiment of the present invention.

FIG. 3A is a side view of a root watering and feeding device with a detached liquid collection basin, according to an embodiment of the present invention.

FIG. 3B is a side view of the root watering and feeding device with the liquid collection basin attached, according to an embodiment of the present invention.

FIG. 4A is an exploded view of an unassembled root watering and feeding device, according to an embodiment of the present invention.

FIG. 4B is a perspective view of the assembled root watering and feeding device, according to an embodiment of the present invention.

FIG. 5A is a side view of a liquid collection basin, according to an embodiment of the present invention.

FIG. 5B is a perspective view of the liquid collection basin, according to an embodiment of the present invention.

FIG. 6 is a perspective view of a liquid collection basin, according to an embodiment of the present invention.

FIG. 7 is a perspective view of a pointed member, according to an embodiment of the present invention.

FIG. 8 is a side view of an elongated hollow tube with handles, according to an embodiment of the present invention.

FIG. 9. is a side view of an elongated hollow tube with a split distal end to be inserted into a receptacle of a liquid collection basin, according to an embodiment of the present invention.

FIG. 10 is a side view of a tube-and-rod combination, according to an embodiment of the present invention.

FIG. 11A is a top view of a button, according to an embodiment of the present invention.

FIG. 11B is a side view of the button, according to an embodiment of the present invention.

### DETAILED DESCRIPTION OF THE EMBODIMENTS

Some embodiments of the present invention pertain to a root watering and feeding device that is configured to capture rain or sprinkler water and to deliver the water to the root systems of plants. Such embodiments may also be filled manually. The root watering and feeding device may be inserted to a sufficient depth and at a position so as to provide water near, but not directly inside, the plant root system for plants that need a deeper or wider root system. This water and/or liquid nutrient delivery encourages a deeper and wider root system, which is beneficial for stronger and healthier plants. The delivered water and/or liquid nutrients will moisten the soil and encourage the roots to grow downward and outward toward the moisture. The device can deliver water and/or nutrients to outside plants, house plants, potted outside plants, or any other plants by insertion directly into the root system. Insertion deep into the root system of potted plants will allow the water to remain in the soil longer due to a slower evaporation rate. For indoor applications, such embodiments facilitate indoor watering and eliminate spillage by bypassing the leaves and channeling water and/or liquid nutrients to the roots.

Some embodiments include an interchangeable water liquid collection basin that is tapered toward the bottom, and that terminates into a relatively short female orifice, or downspout. This short female orifice at the bottom of the liquid collection basin may receive the male end of a hollow elongated tube of various diameters and lengths configured to press fit, screw into, or otherwise connect with the liquid collection basin. The distal end of the elongated hollow tube may be pointed to facilitate insertion into the soil, or may have an attached pointed member. The pointed member may be separable in some embodiments. The pointed distal end of the elongated tube may be hollow and may have holes to facilitate water delivery (e.g., two small holes in some embodiments).

A plurality of perforations are formed around the circumference of the elongated hollow tube in a desired pattern in some embodiments. However, any amount of the circumference may be covered in some embodiments. The perforations may only be included on part of the hollow tube. For instance, in some embodiments, the perforations are included on the distal quarter (i.e., one-fourth) of the elongated hollow tube.

The root watering and feeding device may be configured such that water and/or liquid nutrients are collected in the basin and funneled downward into the elongated, hollow tube, where they are dispersed into the soil through the plurality of perforations on the tube. In some embodiments, the width, depth, and/or shape of the liquid collection basin may be configured based on the climate. For instance, in arid climates, a wide, shallow basin may be preferable to capture more of the precious little rainfall that occurs. In wet climates, a deeper, narrower basin may be beneficial to have a more compact size that is still able to capture a sufficient quantity of the more generous rainfall levels.

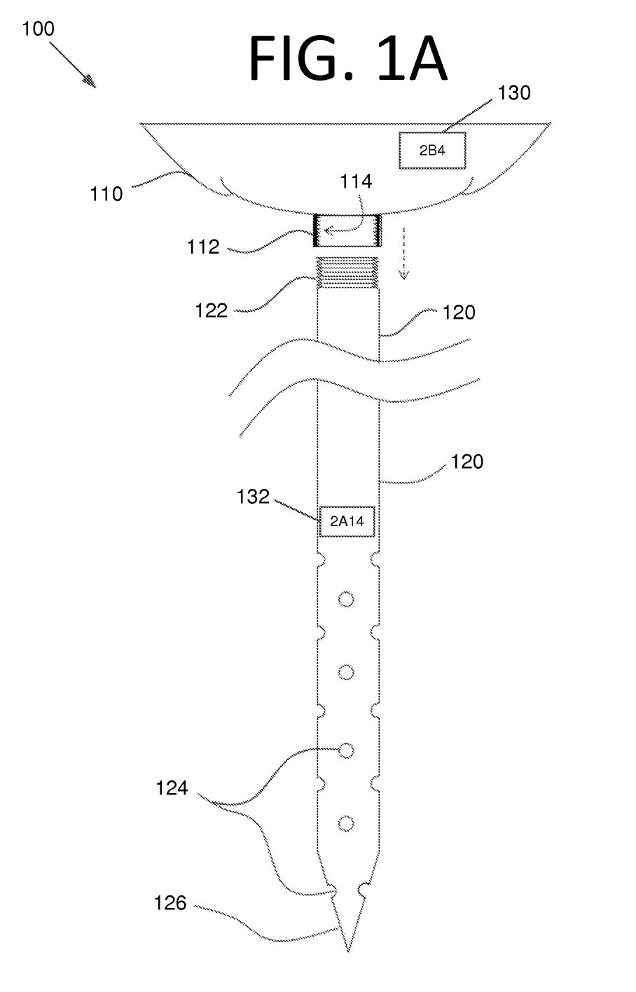

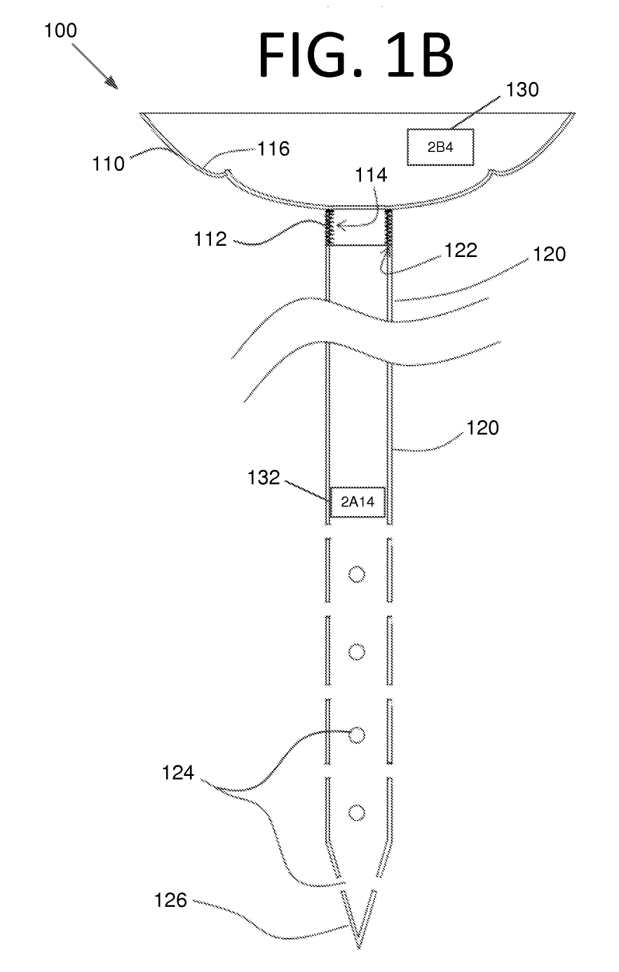

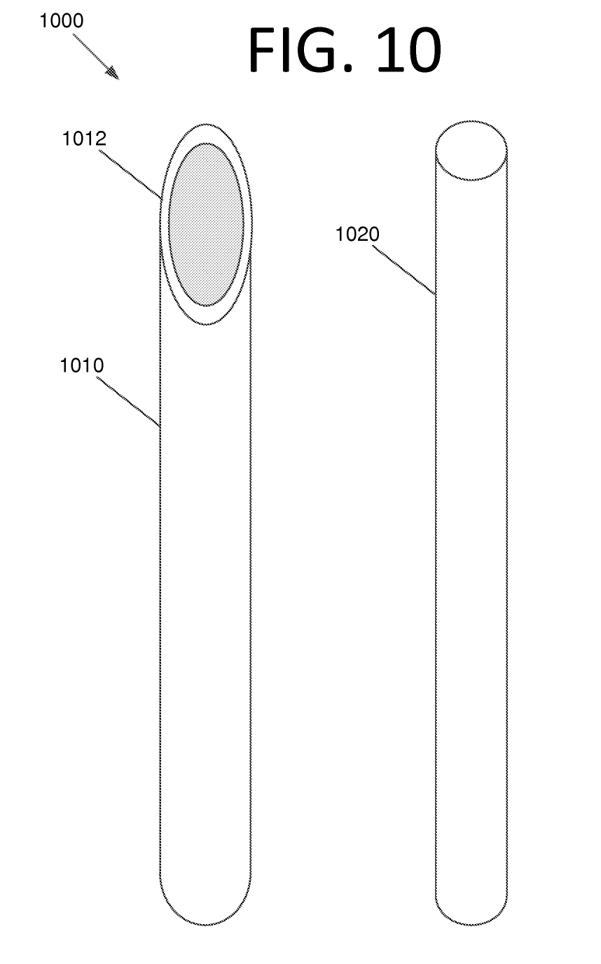

FIG. 1A is a side view of a root watering and feeding device 100 with a detached liquid collection basin 110, according to an embodiment of the present invention. Liquid collection basin 110 has a hollow downspout 112. An interior threaded portion 114 of hollow downspout 112 is threaded to receive a threaded proximal end 122 of elongated hollow tube 120. A lower portion of elongated hollow tube 120 includes perforations 124 around its circumference—in this embodiment, 360 degrees around elongated hollow tube 120. However, any portion of the circumference, any vertical height, any size of perforations, and/or any pattern of perforations may be used as a matter of design choice. Elongated hollow tube 120 terminates in a point at a distal end 126. Distal end 126 may be either a terminal point or an open end (see, for example, FIG. 10) that receives a separate pointed member to be inserted into the orifice.

FIG. 1B is a side view of root watering and feeding device 100 with liquid collection basin 110 attached to elongated hollow tube 120, according to an embodiment of the present invention. Liquid collection basin 110 has a bowl-shaped configuration, with downwardly sloped walls 116 that provide drainage into hollow downspout 112. In this way, water and/or liquid nutrients may be collected into liquid collection basin 110 via rain water, sprinkler water, poured water/nutrients, or any other desired water or nutrient source. The water and/or liquid nutrients are then delivered into the subsurface soil directly below and around the root area or into the root system of the plant in the manner described below. Beneficially and economically, basin 110 also directs rainwater directly below ground to the roots.

In this embodiment, the internal diameter of hollow downspout 112 is slightly larger than the external diameter of threaded proximal end 122 of elongated hollow tube 120 such that interior threaded portion 114 and threaded proximal end 122 may be screwed together, securing liquid collection basin 110 to elongated hollow tube 120. This collectively forms root watering and feeding device 100, which is now ready for use. Liquid collection basin 110 may be interchangeable and part of a kit of different liquid collection basins, such that various sizes, designs, and colors of liquid collection basin 110 can be attached to elongated hollow tube 120. Furthermore, kits in some embodiments may include multiple liquid collection basins and multiple elongated hollow tubes. In certain embodiments, the liquid collection basin and elongated hollow tube may be integrally formed as a single unit, where both are molded from the same material.

In some embodiments, the size and perforation patterns of the elongated hollow tube may be varied based on the plant or type of plant that is to be watered (e.g., trees, small flowers, shrubs, plants with similar root structures, etc.). For instance, to water trees, the elongated hollow tube may be longer so as to reach deeper root systems. Also, the location of the perforations may be changed based on the nature of the growth of the root system of the given plant. Furthermore, the size of the perforations may be modified based on the type of plant. For instance, for plants requiring a larger amount of water, the perforations may be larger, whereas for plants requiring a smaller amount of water, the perforations may be smaller. Plants sold at a retailer may be labeled with a color, number, model name or number, a combination designation (i.e., one for each of the elongated hollow tube and the liquid collection basin), or any other suitable designation or designations so that consumers know which combination of elongated hollow tube and liquid collection basin is most suitable for the root watering and feeding device for the plants they purchase.

Returning to FIGS. 1A and 1B, liquid collection basin 110 includes a basin design label 130 and elongated hollow tube 120 includes a tube design label 132. In this embodiment, for basin design label 130, the first number designates the width, the letter designates the bowl shape, and the second number designates the bowl depth. For tube design label 132, the first number designates the tube width, the letter designates the perforation pattern, and the second number designates the tube length. A sample designation system in shown in Tables 1 and 2 below.

TABLE 1
EXAMPLE BASIN DESIGNATIONS

| Width | | | | | |
|---|---|---|---|---|---|
| Label: | Width: | Type Label: | Type: | Depth Label: | Depth: |
| 1 | 2″ | A | Shallow Cone | 1 | 1″ |
| 2 | 4″ | B | Deep Cone | 2 | 2″ |
| 3 | 6″ | C | Shallow Cup | 3 | 4″ |
| 4 | 12″ | D | Deep Cup | 4 | 6″ |
| 5 | 24″ | E | Dish | 5 | 12″ |

TABLE 2
EXAMPLE TUBE DESIGNATIONS

| | | Pattern | | Length | |
|---|---|---|---|---|---|
| Width Label: | Width: | Label: | Pattern Type: | Label: | Length: |
| 1 | ½″ | A | Small Continuous | 1 | 4″ |
| | | | Holes, Quarter | | |
| | | | Height | | |
| 2 | 1″ | B | Medium | 2 | 6″ |
| | | | Continuous | | |
| | | | Holes, Quarter | | |
| | | | Height | | |
| 3 | 2″ | C | Large Continuous | 3 | 12″ |
| | | | Holes, Quarter | | |
| | | | Height | | |
| 4 | 3″ | D | Small Continuous | 4 | 24″ |
| | | | Holes, Half | | |
| | | | Height | | |
| 5 | 4″ | E | Medium | 5 | 48″ |
| | | | Continuous | | |
| | | | Holes, Half | | |
| | | | Height | | |
| — | — | F | Large Continuous | — | — |
| | | | Holes, Quarter, | | |
| | | | Height | | |
| — | — | G | Alternating Small | — | — |
| | | | and Medium | | |
| | | | Continuous | | |
| | | | Holes, Quarter | | |
| | | | Height | | |
| — | — | H | Alternating | — | — |
| | | | Medium and | | |
| | | | Large Continuous | | |
| | | | Holes, Quarter | | |
| | | | Height | | |
| — | — | I | Alternating Small | — | — |
| | | | and Medium | | |
| | | | Continuous | | |
| | | | Holes, Half | | |
| | | | Height | | |
| — | — | J | Alternating | — | — |
| | | | Medium and | | |
| | | | Large Continuous | | |
| | | | Holes, Half | | |
| | | | Height | | |
| — | — | K | Small Half- | — | — |
| | | | Circumference | | |
| | | | Holes, Quarter | | |
| | | | Height | | |
| — | — | L | Medium Half- | — | — |
| | | | Circumference | | |
| | | | Holes, Quarter | | |
| | | | Height | | |
| — | — | M | Large Half- | — | — |
| | | | Circumference | | |
| | | | Holes, Quarter | | |
| | | | Height | | |
| . . . | . . . | . . . | . . . | . . . | . . . |

Any suitable designation system may be used and any length, width, depth, shape, and/or perforation pattern may be designated.

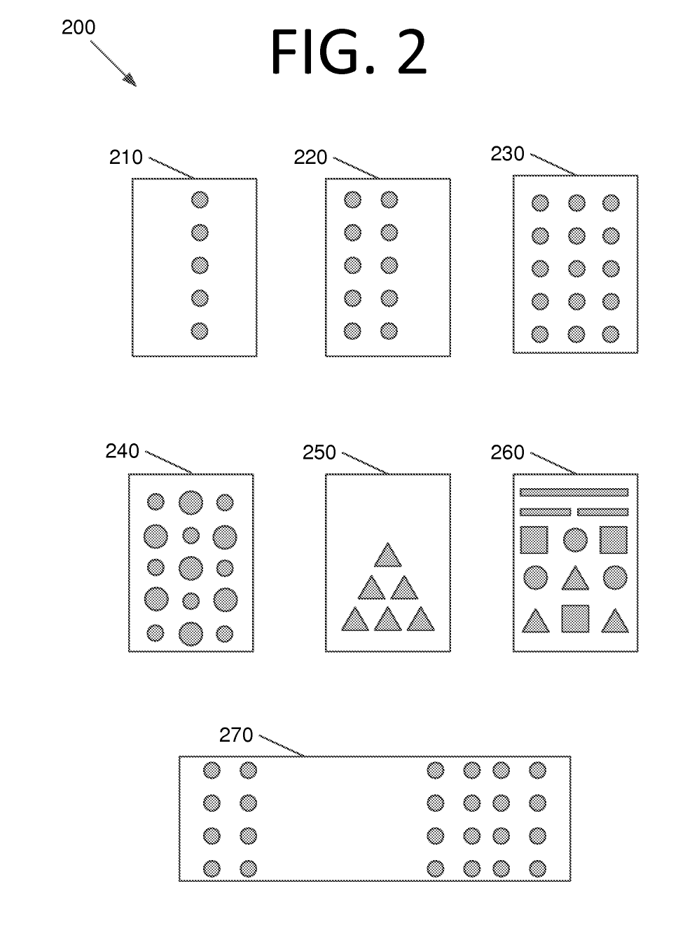

FIG. 2 is a side view of multiple elongated tube sections 200 with different perforation patterns and shapes, according to an embodiment of the present invention. FIG. 2 provides a non-limiting example of some of the perforation shapes, patterns, and combinations thereof in some embodiments. For instance, section 210 includes a vertical line pattern of uniform perforations, section 220 includes uniform perforations on one side of the tube circumference only, section 230 includes uniform perforations throughout, section 240 includes alternating perforation sizes throughout, section 250 includes a triangle pattern of triangle shaped perforations, section 260 includes triangle, square, circle, and rectangle/slit shaped perforations, and section 270 includes two sections with perforations and a section without perforations.

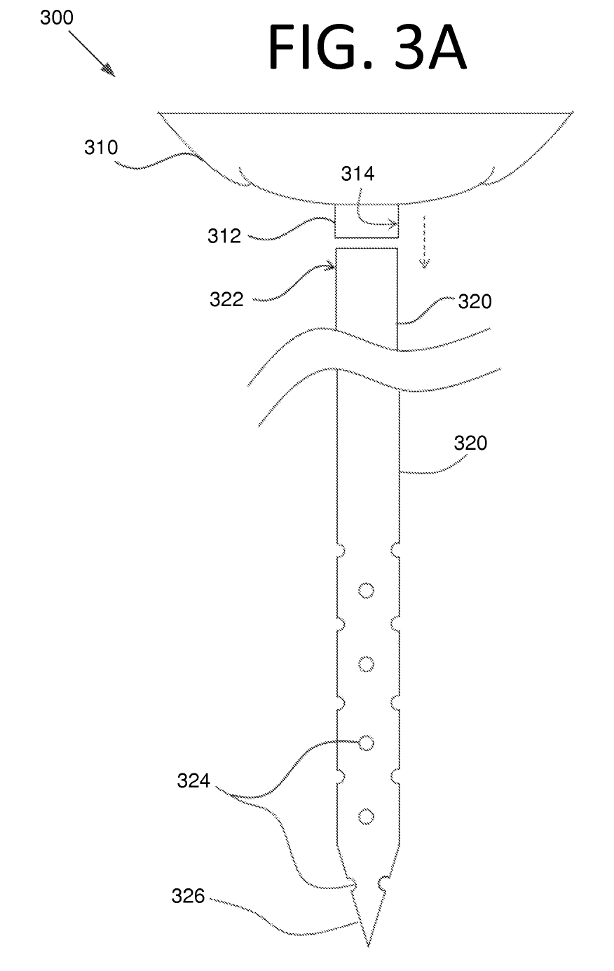

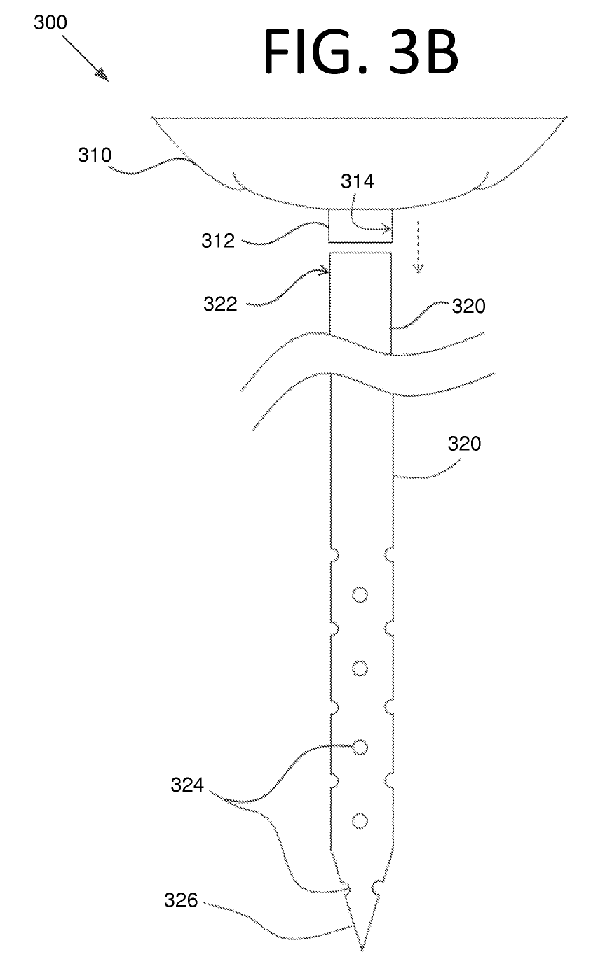

FIGS. 3A and 3B are side views of a root watering and feeding device 300 with a liquid collection basin 310 attached and detached, respectively, with a press fit configuration, according to an embodiment of the present invention. An internal diameter a downspout 312 is slightly larger than an external diameter of a proximal end 322 of an elongated hollow tube 320 so that the parts are secured to one another by pressing downspout 312 onto proximal end 312 of elongated hollow tube 320. The interior of downspout 312 is slightly tapered from the distal end thereof toward the bowl of liquid collection basin 310. Proximal end 322 of elongated hollow tube 320 is cut slightly toward the pointed end in order to allow it to compress and fit snuggly into tapered downspout 312. Once pressed together, root watering and feeding device 300 is for use. Liquid collection basin 110 is intended to be interchangeable in this embodiment so that various sizes, designs, and colors of liquid collection basin 310 can be attached to elongated hollow tube 320.

A distal end 326 of elongated hollow tube 320 is pointed to allow for easy insertion into the soil. Also, in this embodiment, distal end 326 of elongated hollow tube 320 is perforated to allow water do disperse downward into the soil. Perforations 324, collectively denoted, are formed in the distal portion of elongated hollow tube 320. In this embodiment, perforations 324 are formed over the entire circumference of the part of elongated hollow tube 320 that they cover.

To use root watering and feeding device 300, distal end 326 may be plunged into the soil using hand pressure while holding elongated hollow tube 320 until the uppermost portion of perforations 324 is just below the root system of the plant. This depth may be 8-12 inches below the top of the soil and the location may be laterally from the plant at the outer edge of the root system. Thus when properly installed, perforations 324 are below most or all of the plant roots vertically and at the outside edge of the plant root system horizontally. When water and/or liquid nutrients are distributed through root watering system 300, the soil becomes wet at the edges of the roots, softening the soil, and encouraging root growth into the direction of the wet soil. This results in a longer, deeper, and wider root system and a plant that is healthier and can better withstand drought conditions. This location may be the ideal location to supply water and liquid nutrients to plant roots for certain plants in order to facilitate a healthy and hearty plant. Root watering and feeding device 300 can also be inserted directly into the root system so that nutrients and/or water can be applied directly.

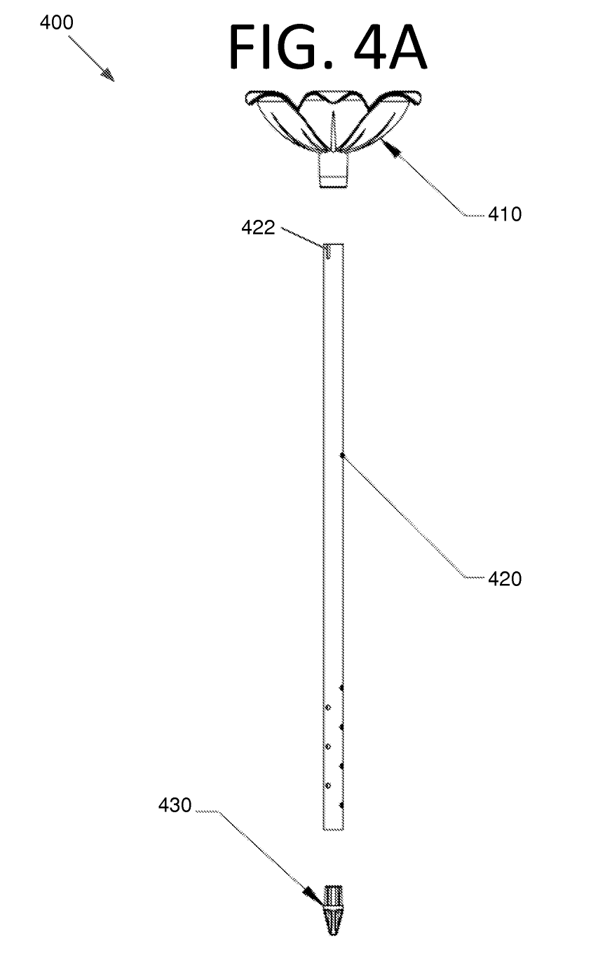

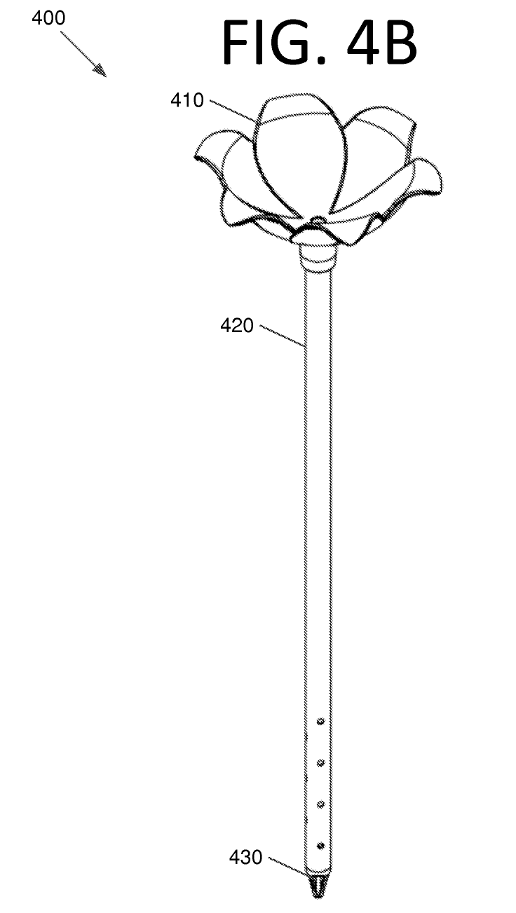

FIGS. 4A and 4B show an exploded view and a perspective view of an unassembled and an assembled root watering and feeding device 400, respectively. Root watering and feeding device 400 includes a liquid collection basin 410, an elongated hollow tube 420, and a pointed member 430 that enables assembled root watering and feeding device 400 to be driven into the ground. In this embodiment, elongated hollow tube 420 has a pair of slits 422 at its proximal end that enable a better press fit between elongated hollow tube 420 and liquid collection basin 410.

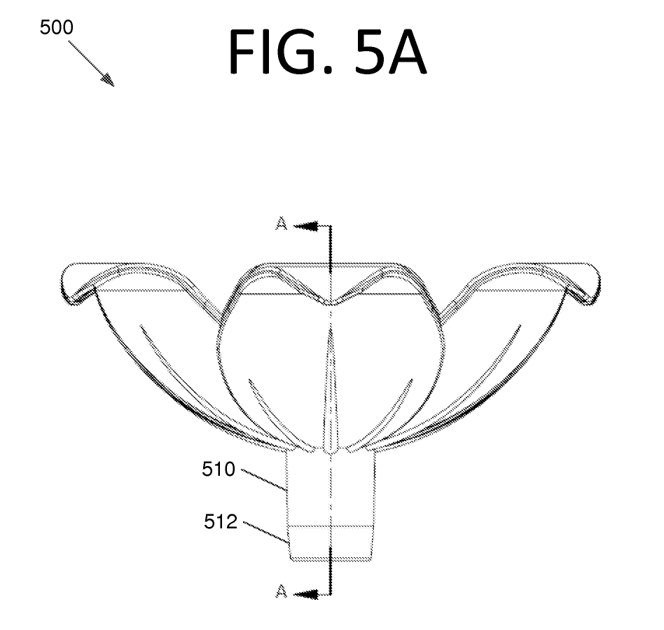

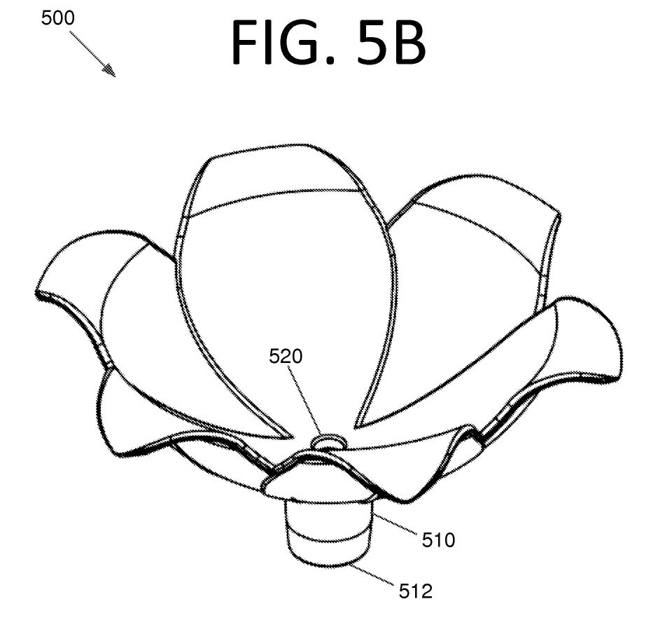

FIGS. 5A and 5B are a side view and a perspective view, respectively, of a liquid collection basin 500, according to an embodiment of the present invention. Liquid collection basin 500 includes a downspout 510 with a beveled end 512. A hole 520 allows water to flow from liquid collection basin 500 to an elongated hollow tube (not shown).

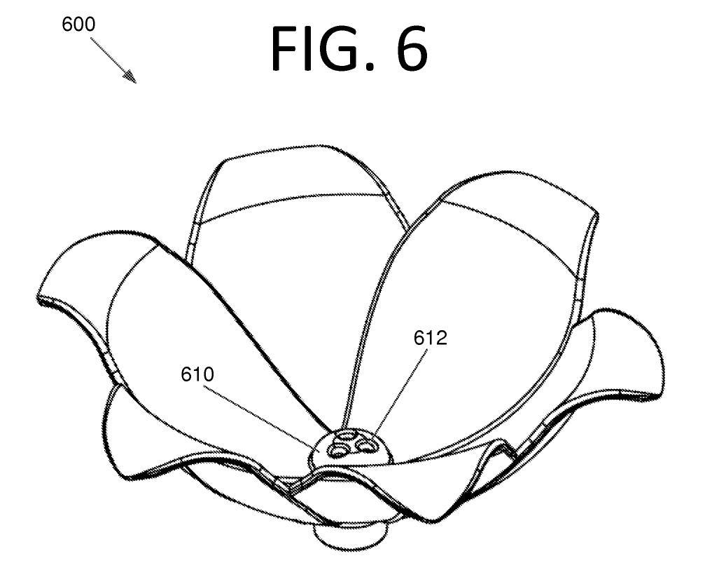

FIG. 6 is a perspective view of a liquid collection basin 600, according to an embodiment of the present invention. In this embodiment, liquid collection basin 600 includes a button (or ovule) 610 that rises up from a center of liquid collection basin 600. Button 610 includes three holes 612 to allow water to flow downward through liquid collection basin 600. However, any number, size, and location of holes 612 may be used as a matter of design choice. Furthermore, button 610 may have various shapes as a matter of design choice. For instance, button 610 may be relatively circular, elliptical, square, rectangular, etc. In this configuration, some water collects in liquid collection basin 600, but does not flow downward. This creates a small pool, which is aesthetically pleasing.

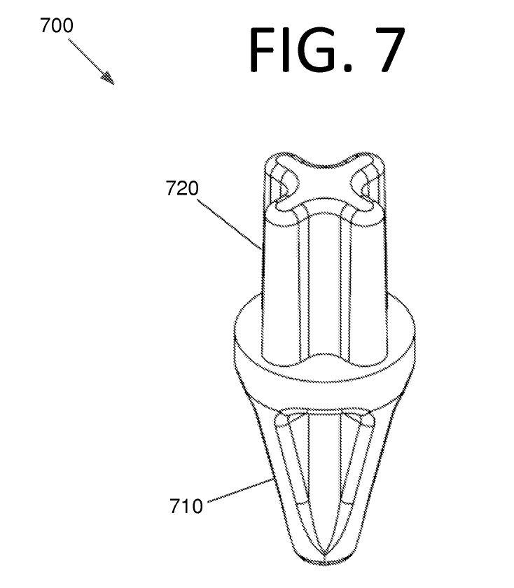

FIG. 7 is a perspective view of a pointed member 700, according to an embodiment of the present invention. Pointed member 700 includes a pointed tip 710 and a connecting member 720. Pointed member connects to an elongated hollow tube (not shown) and allows it to more readily be driven into the ground. Pointed member 700 may be pressed and glued into the distal end of the elongated hollow tube.

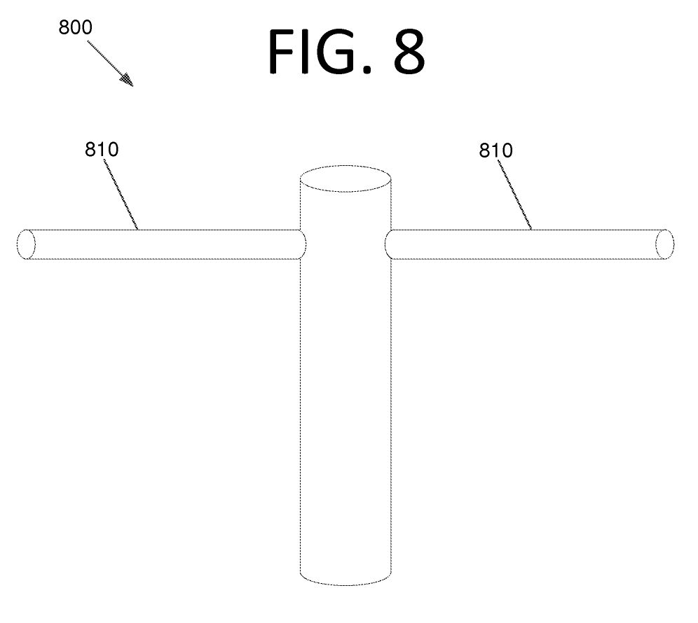

FIG. 8 is a side view of an elongated hollow tube 800 with handles 810, according to an embodiment of the present invention. Handles 810 provide leverage that enables a user to more effectively drive the root watering and feeding device into the ground. Also, users can twist the root watering and feeding device while applying pressure, further assisting in driving the device into the ground.

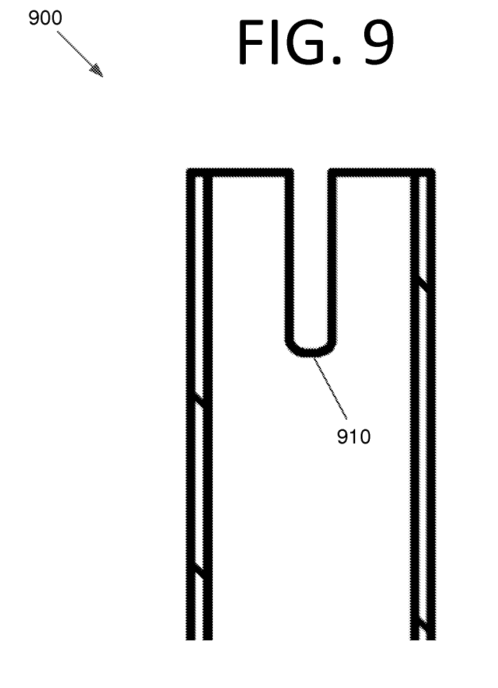

FIG. 9. is a side view of an elongated hollow tube 900 with a split distal end 910 to be inserted into a receptacle of a liquid collection basin, according to an embodiment of the present invention. Split distal end 910 provides a more snug fit into the liquid collection basin.

FIG. 10 is a side view of a tube-and-dowel combination 1000, according to an embodiment of the present invention. An elongated hollow tube 1010 includes a tapered end 1012 that is hollow and may be pressed into the ground. In order to remove dirt, clay, and any other material that may collect in elongated hollow tube 1010 as a result of being driven into the ground, a dowel 1020 is provided. Dowel 1020 is sized so as to be inserted into elongated hollow tube to clean out this material.

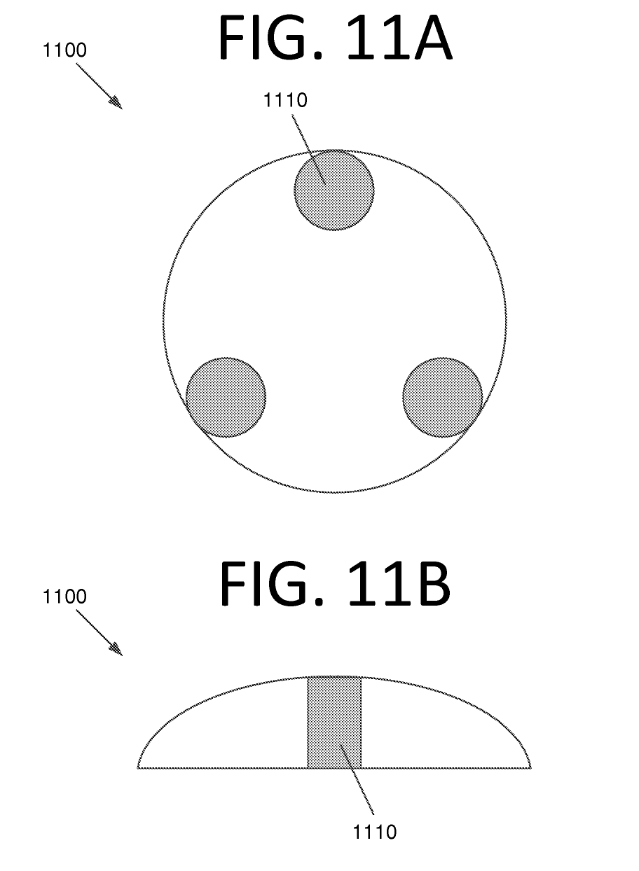

FIGS. 11A and 11B are top and side views, respectively, of a button 1100, according to an embodiment of the present invention. In this embodiment, button 1100 includes three holes 1110 positioned at the edges thereof. Furthermore, at least part of each hole is open and exposed on the side of button 1100. By placing the holes in this manner, all or nearly all of the water can drain from the liquid collection basin so that no pool of water forms.

It will be readily understood that the components of various embodiments of the present invention, as generally described and illustrated in the figures herein, may be arranged and designed in a wide variety of different configurations. Thus, the detailed description of the embodiments of the present invention, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. An apparatus, comprising:
an elongated hollow tube comprising a plurality of perforations; and
a detachable and interchangeable liquid collection basin configured to be attached to and detached from the elongated hollow tube at a proximal end thereof.

2. The apparatus of claim 1, wherein the liquid collection basin, the elongated hollow tube, or both, are part of a kit comprising a plurality of interchangeable liquid collection basins, a plurality of elongated hollow tubes, or both a plurality of interchangeable liquid collection basins and a plurality of elongated hollow tubes.

3. The apparatus of claim 1, wherein the liquid collection basin further comprises a hollow downspout configured to be operably connected to the proximal end of the elongated hollow tube.

4. The apparatus of claim 3, wherein an internal diameter of the hollow downspout is larger than an external diameter of the proximal end of the elongated hollow tube.

5. The apparatus of claim 1, wherein a perforation size, a perforation pattern, a perforation location, or any combination thereof are configured based on a plant or type of plant to be watered.

6. The apparatus of claim 1, wherein the elongated hollow tube, the liquid collection basin, or both, are provided with a designation indicating one or more plants or plant types that the elongated hollow tube, the liquid collection basin, or both, are configured to water.

7. The apparatus of claim 1, wherein a distal end of the elongated hollow tube is tapered and open, and the apparatus further comprises a dowel configured to be inserted into the elongated hollow tube to remove material from the elongated hollow tube.

8. The apparatus of claim 1, wherein perforations are located on only one side of the elongated hollow tube.

9. The apparatus of claim 1, wherein the perforations comprise a plurality of different shapes.

10. The apparatus of claim 1, wherein the liquid collection basin is configured for a specific climate in which it is to be used.

11. The apparatus of claim 1, further comprising:
a detachable pointed member configured to be attached to and detached from a distal end of the elongated hollow tube.

12. The apparatus of claim 1, wherein the elongated hollow tube comprises at least one slit that enables a better press fit between the elongated hollow tube and the liquid collection basin.

13. The apparatus of claim 1, wherein the liquid collection basin comprises a button comprising at least one hole such that a pool of water collects in the liquid collection basin, but does not flow downward through the elongated hollow tube.

14. The apparatus of claim 1, wherein the liquid collection basin comprises a button comprising at least one hole positioned and configured such that the at least one hole is at least partially open on a side of the button so a pool of water does not collect in the liquid collection basin, but instead flows downward through the elongated hollow tube.

15. The apparatus of claim 1, further comprising:
a plurality of handles operably connected to the elongated hollow tube such that a distal end of the elongated hollow tube may be driven into the ground more easily.

16. A root watering and feeding kit, comprising:
an elongated hollow tube comprising a plurality of perforations; and
a plurality of detachable and interchangeable liquid collection basins configured to be attached to and detached from the elongated hollow tube at a proximal end thereof.

17. The root watering and feeding kit of claim 16, further comprising:
at least one additional elongated hollow tube configured to attach to at least one of the plurality of liquid collection basins.

18. The apparatus of claim 17, wherein a perforation size, a perforation pattern, a perforation location, or any combination thereof of the elongated hollow tubes are configured based on a plant or a type of plant to be watered.

19. The root watering and feeding kit of claim 16, wherein at least one of the liquid collection basins comprises a button comprising at least one hole such that a pool of water collects in the liquid collection basin, but does not flow downward through the elongated hollow tube.

20. The root watering and feeding kit of claim 16, wherein at least one of the liquid collection basins comprises a button comprising at least one hole positioned and configured such that the at least one hole is at least partially open on a side of the button so a pool of water does not collect in the liquid collection basin, but instead flows downward through the elongated hollow tube.

21. A root watering and feeding device, comprising:
an elongated hollow tube comprising a plurality of perforations; and
a detachable and interchangeable liquid collection basin configured to be attached to and detached from the elongated hollow tube at a proximal end thereof, wherein
the elongated hollow tube, the liquid collection basin, or both, comprise a designation indicating one or more plants or plant types that the elongated hollow tube, the liquid collection basin, or both, are configured to water.

22. The root watering and feeding device of claim 21, wherein the liquid collection basin comprises a button comprising at least one hole such that a pool of water collects in the liquid collection basin, but does not flow downward through the elongated hollow tube.

23. The root watering and feeding device of claim 21, wherein the liquid collection basin comprises a button comprising at least one hole positioned and configured such that the at least one hole is at least partially open on a side of the button so a pool of water does not collect in the liquid collection basin, but instead flows downward through the elongated hollow tube.
